(19) United States
(12) Patent Application Publication
(10) Pub. No.: US 2020/0003985 A1
(43) Pub. Date: Jan. 2, 2020

(54) OUTDOOR ARMORED FIBER OPTICAL CABLE

(71) Applicant: Rosenberger Technology (Kunshan) Co., Ltd, Kunshan (CN)

(72) Inventors: Aihui Shen, Kunshan (CN); Daigen Chen, Kunshan (CN); Guang Liu, Kunshan (CN); Shubin Zhai, Kunshan (CN)

(21) Appl. No.: 16/369,526

(22) Filed: Mar. 29, 2019

Related U.S. Application Data
(63) Continuation of application No. PCT/CN2018/102452, filed on Aug. 27, 2018.

(30) Foreign Application Priority Data
Jun. 27, 2018 (CN) 201821000990.9

(51) Int. Cl. G02B 6/44; D02G 3/44; D02G 3/18; D02G 3/02

(52) U.S. Cl. CPC G02B 6/4494; D02G 3/447; D10B 2331/021; D02G 3/02; D02G 3/18

(57) ABSTRACT

The present invention provides an outdoor armored fiber optical cable. By arranging water-blocking yarn parallelly to the optical fiber unit in armoring layer, or additionally arranging the water-blocking yarn in the reinforcing layer, ensure the cable no water leakage, and overall water resistance performance is enhanced. The armoring layer is a spiral steel tube structure, so that the fiber optical cable has excellent bending property, thus the present invention is particularly suitable for harsh outdoor environments.

### CROSS REFERENCE TO RELATED APPLICATIONS

This application is a continuation of International Application No. PCT/CN2018/102452, filed on Aug. 27, 2018, which claims priority to Chinese Patent Application No. 201821000990.9, filed on Jun. 27, 2018, the disclosures of which are hereby incorporated by reference.

### FIELD OF THE INVENTION

The present invention relates to an fiber optical cable structure, and more particularly, to an outdoor armored fiber optical cable.

### BACKGROUND

With the development of the communication industry, fiber optical cables have been widely used and rapidly developed. According to purposes, the fiber optical cables can include outdoor fiber optical cables and indoor fiber optical cables. The outer sheath of the outdoor fiber optical cable is thick and strong, which can be used in harsh environments such as windy, sunbaked, cold, freezing environment, resistance to crush, corrosion, has good tensile performance, and usually is armored (i.e. metal tape wrapped). Outdoor applications include direct burying, pipelining, overhead arrangement, etc.

However, the existing common outdoor armored fiber optical cable has a complex structure and uses water-blocking filling compound to block water. The filling compound needs to be treated during laying, which increases a large amount of labor cost and pollutes the environment. Under long-term high temperature, the fluidity of filling compound increases, and it is easy to seep out at the joint, thus resulting in equipment failure and interruption of fiber optical signal transmission and bringing huge economic loss to the user.

In addition, an armoring layer of the common outdoor armored fiber optical cable is usually made of a corrugated steel tape, which has poor bending property and is not suitable for repeated dragging and retracting in the field.

### SUMMARY OF THE INVENTION

The object of the present invention lies in overcoming the defects of the prior art and providing an outdoor armored fiber optical cable with simple structure, good waterproof character, excellent bending property and dry core structure.

In order to achieve the object above, the present invention puts forward the following technical solution: an outdoor armored fiber optical cable comprises a plurality of optical fiber units, wherein the fiber optical cable further comprises an outer protecting layer, a reinforcing layer and an armoring layer sequentially arranged from outside to inside, the optical fiber unit is arranged in the armoring layer, a first water-blocking yarn is also arranged in the armoring layer, and the optical fiber unit and the first water-blocking yarn are arranged in parallel.

Preferably, the armoring layer is also internally provided with a first reinforcing member, and the first reinforcing member is arranged in parallel with the first water-blocking yarn and the optical fiber unit.

Preferably, a plurality of first water-blocking yarns are arranged.

Preferably, the reinforcing layer comprises a plurality of second water-blocking yarns and second reinforcing member, and the second water-blocking yarn and the second reinforcing member are arranged in parallel.

Preferably, the reinforcing layer comprises the second water-blocking yarn and second reinforcing member, and the second water-blocking yarn and the second reinforcing member are twisted.

Preferably, the optical fiber unit comprises a protecting buffer and the optical fiber arranged in the buffer.

Preferably, the armoring layer is a spiral steel tube structure.

Preferably, the first reinforcing member is aramid yarn or glass yarn.

Preferably, the second reinforcing member is aramid yarn or glass yarn.

Preferably, the outer protecting layer is made of a wear-resistant elastomer material.

Preferably, 2 to 12 optical fiber units are arranged in the armoring layer.

The present invention has the beneficial effects that the structure is simple, the waterproof effect is good, the bending property is excellent, and the dry water resistance is available, thus making the present invention suited to harsh outdoor environments.

### BRIEF DESCRIPTION OF THE DRAWINGS

FIG. 1 is a structure diagram of an embodiment of the present invention.

FIG. 2 is a structure diagram of another embodiment of the present invention.

FIG. 3 is a structure diagram of an optical fiber unit of the present invention, and

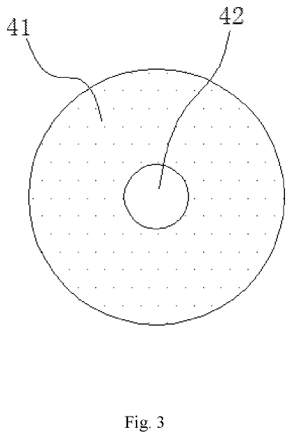

FIG. 4 is a stereoscopic structure diagram of the present invention.

### REFERENCE NUMERALS

10 refers to armoring layer, 20 refers to reinforcing layer, 30 refers to outer protecting layer, 40 refers to optical fiber unit, 41 refers to protecting buffer, 42 refers to optical fiber, 50 refers to first/second water-blocking yarn, 60 refers to first/second reinforcing member.

### DETAILED DESCRIPTIONS OF THE PREFERRED EMBODIMENTS

The technical solutions of the embodiments of the present invention are clearly and completely described hereinafter with reference to the drawings of the present invention.

The present invention discloses an outdoor armored fiber optical cable. By arranging a water-blocking yarn 50 parallel to an optical fiber unit 40 in an armoring layer 10, and directly arranging the water-blocking yarn in a buffer formed by the armoring layer, or additionally arranging the water-blocking yarn 50 in a reinforcing layer 20, overall water-blocking of the fiber optical cable is ensured, and overall water resistance of the fiber optical cable is increased, thus making the present invention suited to harsh outdoor use environments.

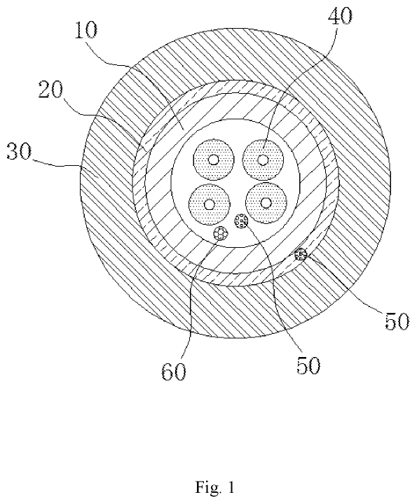

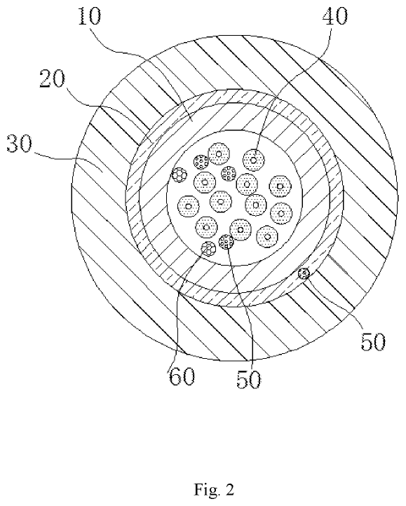

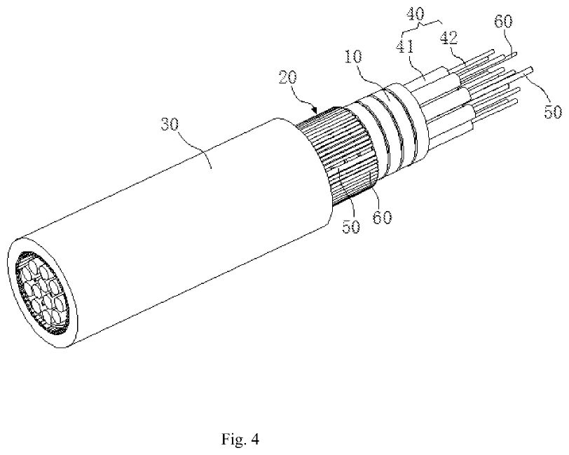

With reference to FIG. 1, FIG. 2 and FIG. 4, an outdoor armored fiber optical cable disclosed by the embodiment of the present invention comprises an armoring layer 10, a reinforcing layer 20 and an outer protecting layer 30 sequentially arranged from inside to outside, wherein the armoring layer 10 is internally provided with a plurality of optical fiber units 40 and a plurality of first water-blocking yarns 50, and in the embodiment as shown in FIG. 1, 4 optical fiber units 40 and 1 first water-blocking yarn 50 are arranged in the armoring layer 10. In the other alternative embodiment as shown in FIG. 2, 12 optical fiber units 40 and three first water-blocking yarns 50 are arranged in the armoring layer 10. In specific implementation, 2 to 12 optical fiber units 40 are preferably arranged, and that is, 2 to 12 cores fiber optical cables are formed and 1 to 3 water-blocking yarns 50 are formed. Certainly, other multi-core structures and other numbers of water-blocking yarns 50 may be arranged.

As shown in FIG. 4, each optical fiber unit 40 comprises a protecting buffer 41 and optical fiber 42 arranged in the protecting buffer 41.

Preferably, with reference to FIGS. 1, 2 and 4, in the embodiment, the first water-blocking yarn 50 is arranged in parallel with the optical fiber unit 40 in the armoring layer 10, the first water-blocking yarn 50 is directly arranged in the buffer formed by the armoring layer 10, compared with a twisting mode, the parallel arrangement mode enables the first water-blocking yarn 50 to reduce the compression and extrusion to the optical fiber unit 40 when the first water-blocking yarn 50 expands with water, thus affecting the transmission of sensitive optical fiber unit 40, so as to improve the signal transmission quality of the optical fiber unit 40. Moreover, the increase of the first water-blocking yarn 50 enhances the overall waterproof effect of the fiber optical cable, so that the fiber optical cable can completely realize outdoor applications such as direct burying, pipelining, and overhead arrangement.

More preferably, the armoring layer 10 may also be internally provided with a first reinforcing member 60, the first reinforcing member 60 is arranged in parallel with the first water-blocking yarn 50 and the optical fiber unit 40, and the first reinforcing member 60 may be aramid yarn or glass yarn in implementation. The combination of the first reinforcing member 60 and the first water-blocking yarn 50 further improves the flexibility, water resistance and capabilities of compression resistance and tensile strength of the fiber optical cable and has a wide range of environment temperatures for operation and laying.

In the embodiment, a spiral steel tube is used in the armoring layer 10 for armoring, the armoring of a spiral steel tube structure can ensure the mechanical performance of the fiber optical cable, and at the same time, the bending property of the fiber optical cable is increased, and the first reinforcing member 60 and the first water-blocking yarn 50 are added in an ultra-soft armoring pipe of the spiral steel tube structure, so that the fiber optical cable can better adapt to the outdoor environmental, mechanical performance, completely reach the IEC outdoor fiber optical cable standard.

In the embodiment, the reinforcing layer 20 comprises a second reinforcing member 60, and the second reinforcing member 60 here is made of an aramid fiber or glass yarn like the first reinforcing member 60 in the armoring layer 10. Preferably, in order to further increase the waterproof and tensile properties of the fiber optical cable, the reinforcing layer further comprises a plurality of second water-blocking yarns 50, wherein the second water-blocking yarn 50 here and the second reinforcing member 60 can be twisted or arranged in parallel to form a water-blocking reinforcing layer 20, which completely meets the requirements of outdoor waterproof grade. Parallel arrangement is used in the embodiment, and the number of second water-blocking yarns 50 can also be set according to actual needs.

In addition, in the embodiment, the outer protecting layer 30 is made of wear-resistant elastomer material, which further improves the flexibility, water resistance and capabilities of compression resistance and tensile strength of the fiber optical cable in the present invention, so as to have a wide range of environment temperatures for operation and installation, suitable for outdoor environment.

The technical contents and technical features of the present invention have been disclosed above, but those skilled in the art can still make various replacements and modifications not deviating from the spirit of the present invention based on the instruction and disclosure of the present invention. Therefore, the protection scope of the present invention shall include various replacements and modifications not deviating from the present invention instead of being limited to the contents disclosed by the embodiments and is covered by the claims of the application of the patent.

1. An outdoor armored fiber optical cable, comprising a plurality of optical fiber units, wherein the fiber optical cable further comprises an outer protecting layer, a reinforcing layer and an armoring layer sequentially arranged from outside to inside, the optical fiber unit is arranged in the armoring layer, a first water-blocking yarn is also arranged in the armoring layer, and the optical fiber unit and the first water-blocking yarn are arranged in parallel.

2. The outdoor armored fiber optical cable according to claim 1, wherein the armoring layer is also internally provided with a first reinforcing member, and the first reinforcing member is arranged in parallel with the first water-blocking yarn and the optical fiber unit.

3. The outdoor armored fiber optical cable according to claim 1, wherein a plurality of first water-blocking yarns are arranged.

4. The outdoor armored fiber optical cable according to claim 1, wherein the reinforcing layer comprises a plurality of second water-blocking yarns and second reinforcing member, and the second water-blocking yarn and the second reinforcing member are arranged in parallel.

5. The outdoor armored fiber optical cable according to claim 1, wherein the reinforcing layer comprises a plurality of second water-blocking yarns and second reinforcing member, and the second water-blocking yarn and the second reinforcing member are twisted.

6. The outdoor armored fiber optical cable according to claim 1, wherein the armoring layer is a spiral steel tube structure.

7. The outdoor armored fiber optical cable according to claim 1, wherein the first reinforcing member is aramid yarn or glass yarn.

8. The outdoor armored fiber optical cable according to claim 4, wherein the second reinforcing member is aramid yarn or glass yarn.

9. The outdoor armored fiber optical cable according to claim 1, wherein the outer protecting layer is made of a wear-resistant elastomer material.

10. The outdoor armored fiber optical cable according to claim 1, wherein 2 to 12 optical fiber units are arranged in the armoring layer.
